(19) United States
(12) Patent Application Publication
(10) Pub. No.: US 2007/0118264 A1
(43) Pub. Date: May 24, 2007

(54) Method for triggering restraint devices

(76) Inventors: Marc Theisen, Besigheim (DE); Ulrike Mueller, Murr (DE)

Correspondence Address: KENYON & KENYON LLP, ONE BROADWAY, NEW YORK, NY, 10004, US

(21) Appl. No.: 10/550,083

(22) PCT Filed: Oct. 17, 2003
(86) PCT No.: PCT/DE03/03446

§ 371 Date: Aug. 11, 2006

(30) Foreign Application Priority Data
Mar. 17, 2003 (DE) 103 11 524.2

(51) Int. Cl. B60R 22/00

(52) U.S. Cl. 701/45

(57) ABSTRACT

A method for triggering restraint devices is provided, in which the restraint devices are triggered as a function of a collision signal. The method is launched, however, when the collision signal exceeds a noise threshold. Now a time required for the collision signal to exceed the noise threshold is taken into account in determining the triggering time for a specific restraint device.

### FIELD OF THE INVENTION

The present invention is based on a method for triggering restraint devices according to the species defined in the independent claim.

### BACKGROUND INFORMATION

German Patent No. 101 38 764 describes the provision of a noise threshold in a method for triggering restraint devices, in which the method is launched only when a collision signal, as a function of which the restraint devices are triggered, exceeds this noise threshold.

### SUMMARY OF THE INVENTION

By contrast, the method according to the present invention for triggering restraint devices has the advantage that now the time that has passed before the noise threshold of the restraint device is exceeded, but beginning with the collision, is taken into account in the determination of the triggering times for the individual restraint devices. Especially if, in the event of a collision, easily deformable parts of the vehicle are initially indented by the other party involved in the accident, no significant collision signals which are registered by an acceleration sensor, for example, are generated in that case. Only when the other party involved in the accident begins to crush or deform the more rigid parts of the vehicle body are significantly stronger acceleration signals generated. Then the noise threshold is definitely exceeded and the method according to the invention is launched, with the proviso, however, that the accident or collision had already commenced a few milliseconds prior. According to the present invention, this time which passes between the collision and the exceeding of the noise threshold, which is normally 3 to 6 g, is taken into account in the determination of the triggering times so as to improve triggering and to arrive at a more timely firing of the restraint devices. The collision signal may be an acceleration signal, a pressure signal, a temperature signal or another signal from a deformation sensor or even a velocity signal.

Particularly advantageous is the fact that the time between the collision and the exceeding of the noise threshold is taken into account in terms of a fixed time value, which is taken into account in the determination of the triggering times for the various restraint devices. This results in a simple parallel shift of the triggering times as compared to the case in which this time between the collision and the exceeding of the noise threshold would not be taken into account.

Alternatively, it is advantageously possible to determine the duration until the noise threshold is exceeded as a function of the velocity. The collision velocity is used for this purpose. This makes it advantageously possible to control this time between the collision and the exceeding of the noise threshold adaptively. This allows for an even better adaptation to the particular accident situation, when the triggering of the restraint devices is determined. Finally, the method according to the present invention, which is expressed in an algorithm in the control unit, is consequently more precise in determining the suitable triggering times for the individual restraint devices. For this purpose, the collision velocity may be advantageously determined by a pre-crash sensory system, for example with the aid of video, ultrasound, radar or lidar technology.

### BRIEF DESCRIPTION OF THE DRAWINGS

FIG. 1 shows the correlation between collision velocity and triggering time.

FIG. 2 shows the time lapse between the collision and the exceeding of the noise threshold.

FIG. 3 shows a second diagram clarifying the correlation between collision velocity and triggering time.

FIG. 4 shows a third diagram describing the correlation between collision velocity and triggering time.

FIG. 5 shows a block diagram of a device according to the present invention.

FIG. 6 shows a flow chart of the method according to the present invention.

FIG. 7 shows a fourth diagram for the correlation between collision velocity and triggering time.

### DETAILED DESCRIPTION

In systems for the calculation of triggering times for restraint systems, a threshold function is used which is compared to a signal derived from an acceleration signal. This signal may be the acceleration signal itself, or else the integrated acceleration signal, i.e. the velocity signal.

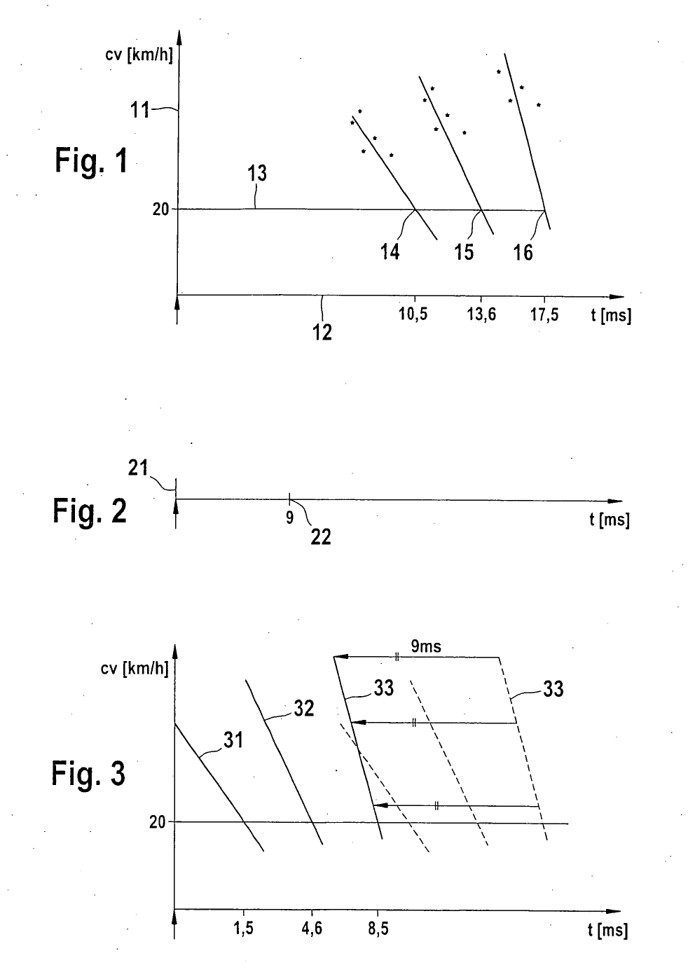

Crash classes are established on the basis of a series of crash tests. In this context, it is possible to combine crash classes having similar triggering times into so-called triggering classes. The correlation between velocity and triggering time is then defined for the individual triggering classes. This is done by extracting this correlation from the data for those crash classes for which many crash tests are available. This extracted functional correlation may be arbitrary, for example, a linear function that can be parameterized. FIG. 1 provides a relevant example. FIG. 1 is a triggering time/collision velocity diagram. Triggering time 12 is plotted in milliseconds on the abscissa, while collision velocity cv 11 is plotted in km/h on the ordinate. Three triggering functions, known as triggering characteristics, are shown here. For specific velocities, in this case for 20 km/h indicated by reference numeral 13, triggering times t_{trig} are extracted from these triggering characteristics. The three triggering characteristics in this example yield the triggering times 10.5 ms, 13.6 ms and 17.5 ms. They are indicated by reference numerals 14 through 16, respectively. These triggering times are stored in a triggering-times table. The triggering times are used as reference points for the threshold function, at each of which one threshold value is stored. The comparison between the acceleration signal, or a signal derived from the acceleration signal, and the threshold function is in each instance carried out at these reference points, i.e. a check is made to ascertain whether this threshold function has been exceeded. If the threshold function has been exceeded, the restraint device is triggered at this time. If the threshold function has not been exceeded, the restraint device is not triggered, and the signal continues to be observed until the next reference point of the triggering time. Signal processing begins once a noise threshold of the acceleration signal has been exceeded. This point in time, however, comes a few milliseconds after the actual contact of the vehicle with the other party involved in the accident. This situation arises due to the fact that, during an accident, initially the soft parts of the vehicle are indented and the associated change in the acceleration signal is not pronounced enough to exceed the noise threshold. The noise threshold is only exceeded once the rigid parts of the vehicle are reached, and this occurs only several milliseconds after the initial contact.

FIG. 2 shows this difference. A timeline in milliseconds demonstrates that the contact is made at time 21, while the noise threshold is exceeded only 9 ms later at time 22. Hence it is clear that the triggering characteristics are no longer sufficiently precise if the time beginning with the noise threshold is used as the collision time. This is of particular significance, especially in the case of a slow crash into a soft barrier.

Hence, the method according to the present invention provides that the time lapse between the collision and the exceeding of the noise threshold is taken into account when determining the triggering time for the relevant restraint devices. First of all, this may be taken into account by allowing for a fixed offset in determining the triggering times, thus by effecting a parallel shift of the triggering times, i.e. the triggering times are reduced compared to how they are initially calculated in the method according to the present invention. This is shown in FIG. 3. FIG. 3 also shows a diagram of the collision velocity over the triggering time. Again, the three triggering characteristics 31, 32 and 33 are indicated, which are now shifted in parallel by 9 ms in accordance with FIG. 2, as the time between the contact and the exceeding of the noise threshold, in such a way that the triggering times are now 1.5, 4.6 and 8.5 ms, i.e. in each case reduced by exactly 9 ms. Triggering characteristics 33old and 33 reflect precisely this parallel shift. An empirical mean, in this case 9 ms, characteristic for the vehicle concerned may be used for this purpose.

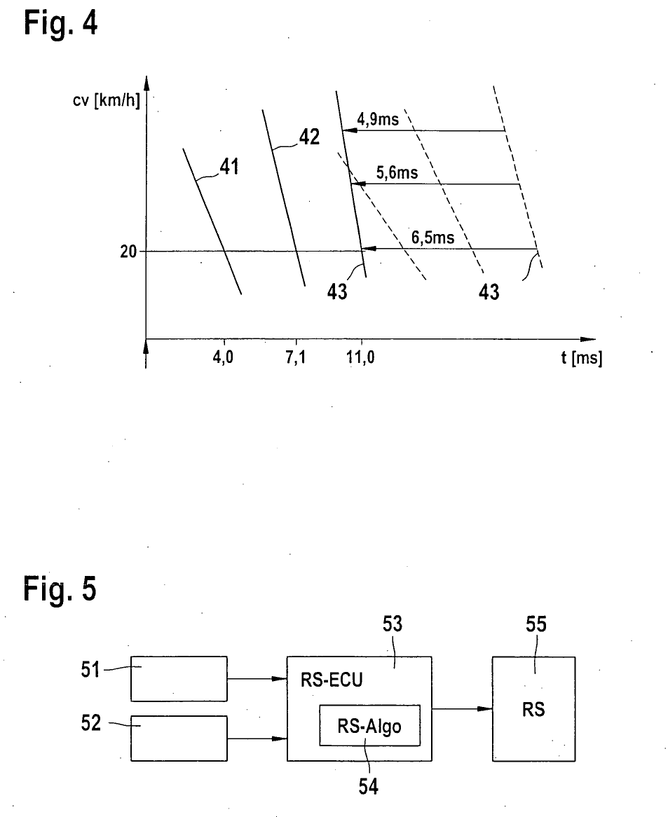

A further refinement, however, provides for an adaptive determination of this time between contact and the exceeding of the noise threshold. The collision velocity is used for this purpose, since it is the determinant parameter which determines the time between contact and the exceeding of the noise threshold for the particular vehicle. This is easy to see, since the faster the other party involved in the accident collides with the vehicle, the shorter is the time between the initial contact and the exceeding of the noise threshold, since the vehicle will now strike the rigid parts of the vehicle more quickly. Thus it is possible, as shown in FIG. 4, that the triggering functions change in terms of their position as well as in terms of their slope. Again, a collision velocity/triggering time diagram is shown. Triggering characteristics 41, 42, 43 have now changed, in terms of their position as well as in terms of their slope, for the various collision velocities. This is shown here in detail with respect to third triggering characteristic 43. For a collision velocity of 20 km/h, a noise-threshold-exceeding time of 6.5 ms was ascertained, while for a higher value, for example, for 30 km/h a value of 5.6 ms and for 40 km/h a value of 4.9 ms was determined. This has changed the position as well as the slope of the triggering characteristic and hence also the corresponding triggering times, which are now 4 ms, 7.1 ms and 11 ms, and specifically for a collision velocity of 20 km/h. This reduces the effect of error which results from the difference between the time of contact and the exceeding of the noise threshold, thus allowing for an even more precise determination of the triggering times for the respective restraint devices.

FIG. 5 shows a device according to the present invention in a block diagram. A pre-crash sensor 51 is used here as a sensor to determine the collision velocity. This sensor is connected to a data input of a control unit for a restraint system 53. A triggering algorithm 54 runs on a processor, e.g. a microcontroller, located in the control unit. In this case, an acceleration sensor 52 is used to determine the collision signal, which is likewise connected to control unit 53. Only one pre-crash sensor 51 and one acceleration sensor 52 are shown here by way of example. It is also possible, however, to provide a plurality of these sensors. Even in control unit 53 itself, acceleration sensors may be installed in different directions for the purpose of plausibilization, for example. It is also possible to provide for a kinematic sensor platform, on which sensors are arranged in different spatial directions. Alternatively, the collision signal may also be determined using a sensor other than an acceleration sensor, for example a pressure, temperature or other type of deformation sensor. Algorithm 54, i.e. control unit 53 then controls restraint devices 55. These restraint devices are airbags for example, preferably of multiple stages, and belt tensioners or even a rollover bar. The connection between the individual components may be established via a bus connection or via specific two-wire connections or a combination of these connection methods.

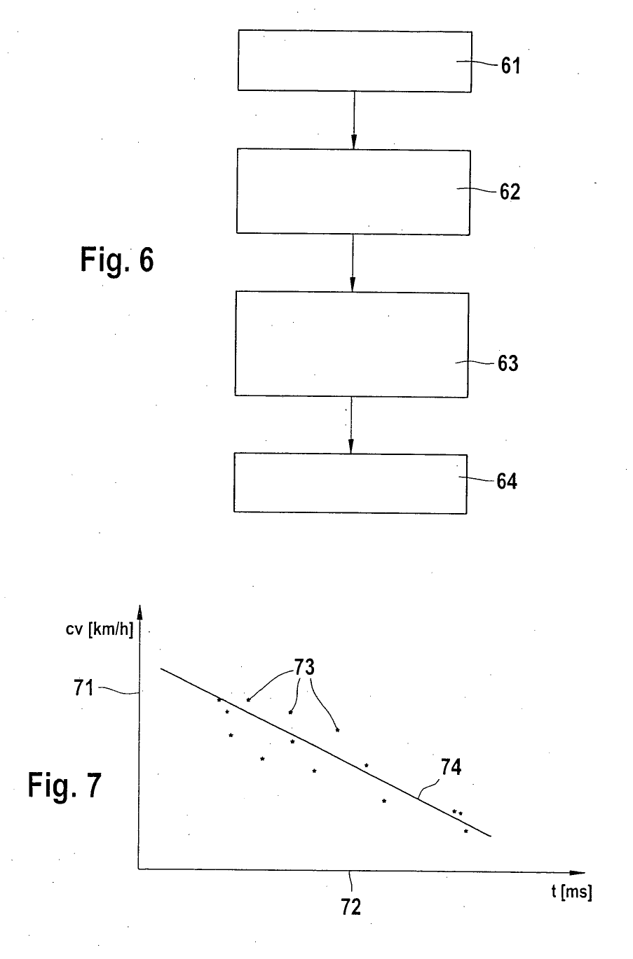

FIG. 6 shows in a flow chart the method according to the present invention which must be used to change the triggering characteristics in such a way that the times up until the exceeding of the noise threshold are taken into account. These new triggering characteristics then form the basis for algorithm 54 running in control unit 53. Based on the set of crash tests provided in method step 61, the times required up until the exceeding of the noise threshold are extracted in method step 62. As shown in FIG. 7, again in a collision velocity/triggering time diagram, these times 72 are entered together with associated collision velocities 71 into a diagram in method step 63. Using these values 73, a regression curve 74 is now established by polynomial approximation, in this example a linear [polynomial approximation], or by interpolation. The corresponding values for every velocity are then gathered from this function and subtracted using the corresponding column of the triggering times table. This occurs in method step 64. This subtraction results in an advancing of the possible triggering times. As shown in FIG. 4, this advancing of triggering functions 41, 42, 43 corresponds, for example, at a velocity of 20 km/h, to approximately 6.5 ms, as is obtained from the comparison of 43old and 43. In this way, the 9 milliseconds required until the noise threshold is exceeded are approximately included. In previous triggering time calculations nothing was subtracted with respect to the triggering times, i.e. the additional 9 ms following the crash were not taken into account. As shown in FIG. 3, the other approaches, in which triggering functions 31, 32, 33 are shifted by a fixed value, as for example from 33old to 33, also take this time into account. What is neglected, however, is the fact that these times may vary with velocity.

1-4. (canceled)

5. A method for triggering a restraint device, comprising:
triggering the restraint device as a function of a collision signal; and
initiating the triggering when the collision signal exceeds a noise threshold, wherein a time required for the collision signal to exceed the noise threshold is taken into account in determining a triggering time for the restraint device.

6. The method as recited in claim 5, wherein the triggering time is taken into account by a fixed offset.

7. The method as recited in claim 5, further comprising:
determining the triggering time as a function of a collision velocity and a crash type.

8. The method as recited in claim 7, further comprising:
determining the collision velocity via a pre-crash sensor.
